(19) United States
(12) Patent Application Publication
(10) Pub. No.: US 2013/0107293 A1
(43) Pub. Date: May 2, 2013

(54) METHOD AND SYSTEM FOR PERSONALIZED DIGITAL PRINTING

(71) Applicants: Ronald L. Uptergrove, Northville, MI (US); William C. Young, Ypsilanti, MI (US)

(72) Inventors: Ronald L. Uptergrove, Northville, MI (US); William C. Young, Ypsilanti, MI (US)

(73) Assignee: Plastipak Packaging, Inc., Plymouth, MI (US)

(21) Appl. No.: 13/599,802

(22) Filed: Aug. 30, 2012

Related U.S. Application Data
(60) Provisional application No. 61/529,490, filed on Aug. 31, 2011.

(51) Int. Cl. G06K 15/02

(52) U.S. Cl. CPC G06K 15/02
USPC 358/1.9; 358/1.18

(57) ABSTRACT

A method for customizable printing a multi-pack of articles includes providing data from a database; electronically generating variable data based on the data from the database; printing variable data on a plurality of articles; and combining the plurality of similar articles to form a multi-pack of articles.

### CROSS-REFERENCE TO RELATED APPLICATION

This application claims the benefit of priority to U.S. Provisional Application No. 61/529,490, filed Aug. 31, 2011, the entire disclosure of which is incorporated herein by reference.

### TECHNICAL FIELD

The present invention relates generally to a method and system for personalized or customized printing of digital images on plastic articles, including, for example, plastic containers having personalized or customized digital images provided thereon.

### BACKGROUND

Consumers are increasingly able to procure customized branded items of various types. However, certain goods, including those that are mass produced, such as plastic containers or bottles, are commonly less available for personalization or customization. Moreover, many articles that may be customized or personalized with digitally printed ink images involve the printing of ink on a web or label that is then applied to the articles. It is desirable to provide customized or personalized industry-acceptable articles, such as plastic containers or bottles, that may be digitally printed in multi-pack form with variable data.

### SUMMARY

A method and system for customizable printing a multi-pack of articles is disclosed. Embodiments of the method and system include providing data from a database, electronically generating variable data based on the data from the database, printing variable data on a plurality of articles, and combining the plurality of similar articles to form a multi-pack of articles.

### BRIEF DESCRIPTION OF THE DRAWINGS

Embodiments of the invention will now be described, by way of example, with reference to the accompanying drawings, wherein:

FIG. 1 generally illustrates a flow chart illustrating an embodiment of a method for creating personalized or customized articles.

FIG. 2 is a general representation of information stored in a database.

FIG. 3 generally illustrates and embodiment of a container including printed variable data thereon.

FIG. 4 generally illustrates an embodiment of a multi-pack of articles.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

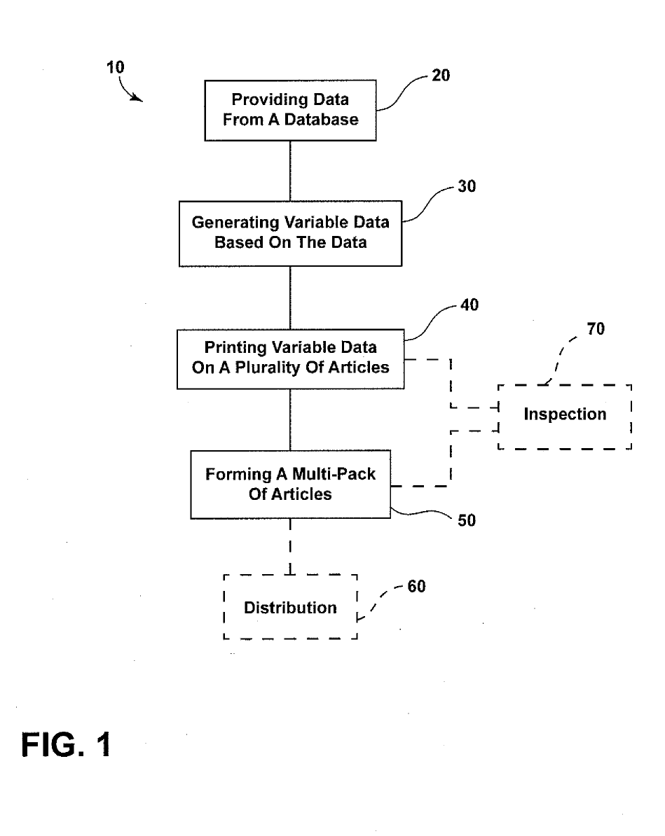

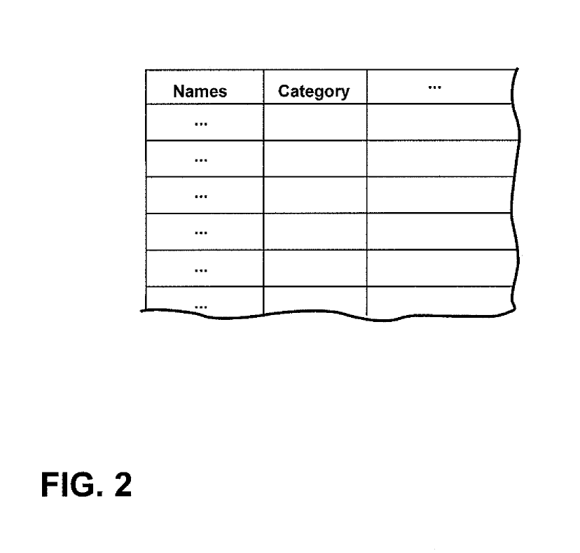

A flow chart illustrating an embodiment of a system or method 10 for creating multi-packs of personalized or customized articles is generally illustrated in FIG. 1. As generally shown at 20, data is provided in a database, which may, for example, comprise a relational database. A representation of information stored in a database is illustrated generally in FIG. 2. In an embodiment, the data included in the database may include demographic data. Further, for some embodiments, the data may include data concerning, without limitation, current events, geographic locations, entertainment, global events, local events, or various combinations of the foregoing.

As generally illustrated at 30, the system or method may involve the generation of variable data based, at least in part, on the data provided in the database. In an embodiment software or other form of routine may electronically generate the variable data. The generation may be “intelligent” in that software or a routine can, for example, determine what variable data (such as images or images and text) is involved and in what order or sequence it will be implemented (e.g., printed). In embodiments, the variable data that is utilized may, for instance, be based on demographic considerations that are utilized by a software or routine.

Further, as generally illustrated at 40, the system or method may involve the printing of variable data on a plurality of articles that are intended to be included in a multi-pack (i.e., package with multiple articles). The articles may, for example and without limitation, comprise a plurality of bottles or containers. In an embodiment, the articles may comprise containers comprised of a plastic material or resin (e.g., acrylonitrile-butadiene-styrene (ABS), polyethylene terephthalate (PET), polystyrene (PS), polyethylene (PE)(including high-density polyethylene (HDPE)), polypropylene (PP), polyvinyl chloride (PVC), etc.). Further, the articles may be mono-layer or multi-layer containers, and can be formed using various conventional forming techniques including, without limitation, injection molding, blow molding, thermoforming, etc. In an embodiment, the outermost layer/surface of the articles may be comprised of a virgin plastic material. Although, it is noted that articles in accordance with the teachings of the disclosure may also include some percentage of recycled content, including a percentage of recycled content in the outer layer of the articles.

In an embodiment, two or more (or even all) of the plurality of articles included in a multi-pack may be substantially identical. In other embodiments, the variable data printed on two or more (or even all) of the plurality of articles included in a multi-pack may differ by individual article.

The printing on successive articles, even though the variable data printed thereon differs, can, if desired, occur in “real time,” i.e., with essentially little or no change-over or sequencing delay associated with or between the printing of successive articles. In embodiments, the variable data to be printed on the next-article-to-be-printed may, for example, be based upon production line accumulations and/or print-repeat factors. For instance, for an embodiment, after a certain number of articles are accumulated, one or more aspects of the variable data to be printed may be modified or eliminated. In another embodiment, a repeat factor may be used to repeat one or more aspects of the variable data in a defined sequence. Further, if desired, elements of randomization may be built into the software or routine associated with the printing of variable data. In some embodiments, the method or system may be configured such that no two articles are the same within a multi-pack, or in general. Such uniqueness or customization associated with the printed variable data may, for instance, be used in connection with various forms of promotions, contests or lotteries. The instant disclosure permits, inter alia, for providing controlled randomization. For example, the intelligence built into the system can permit users to say in a particular “run” that they want every article to be unique, or that they want to skip printing certain variable data on every so many articles.

In embodiments, the printing may be of the type that involves the printing of ink, or ink droplets, which may be curable (e.g., a UV-curable or radiation-curable ink), directly onto a surface of an article. If desired, various forms of ink jet or digital printing, which may involve a subsequent curing process or processes, may be employed. Moreover, for some embodiments, the variable data may be comprised of droplets of ink applied directly to the surface of an article (as opposed to a label or web) in which the printing is multi-colored and single-cured. Further, with some embodiments, a base coat, which for example may be white or clear, can first be applied directly to a surface of the article prior to the application of printed variable data thereupon. Moreover, it is noted that sequential articles may be printed such that, for instance, one article includes a base coat with variable data printed thereon, and the next successive article may not include a base coat. Without limitation, some examples of teachings associated with the digital printing of articles that may be employed in connection with the instant disclosure are included in U.S. Pat. Nos. 7,210,08, 7,625,059, 7,736,713, and 7,910,184, and United States Published Patent Application No. 2007/0264454, U.S. patent application Ser. No. 11/716,447, which are incorporated herein by reference in their entireties.

As generally illustrated at 50, the system or method may involve the assembly or forming of multi-packs of articles. The multi-packs may then be shipped or otherwise distributed (e.g., as generally referenced at 60 in FIG. 1). In embodiments, the multi-packs of articles may be distributed based, at least in part, on demographic data. For example, without limitation, the multi-packs may be distributed based on data that includes current event data, geographic location data, entertainment data, local event data, or combinations of one or more of the foregoing data. The multi-packs may also be distributed to various target customers, for instance, using information associated with the data or database.

The method or system may also involve one or more inspection steps (e.g., as generally illustrated as 70 in FIG. 1). In an embodiment, an inspection system may be utilized to assess or evaluate the printing, including the printed variable data, associated with articles associated with the disclosure. The inspection system may be a quality control-type system, which may, if desired, include various forms of computer vision types of systems.

Because the printed variable data can differ greatly between articles, the inspection system can be configured to take into account the intentional variation that may be provided on an article-by-article basis. That is the inspection step or system may involve a coordination of information or data between what is intended (and instructed) to be printed and what is actually printed, as well as, if desired, whether the printed matter is in an intended position on the associated article or articles. The inspection can then determine if the articles are printed as intended. In an embodiment, a symbol or other graphic, or a physical feature of the article, may be printed or observed as part of the variable data. In embodiments, the method or system may be configured to know what and where the symbol or graphic is intended to be printed and then use the symbol or graphic as a reference (or point of reference) associated with the printed matter.

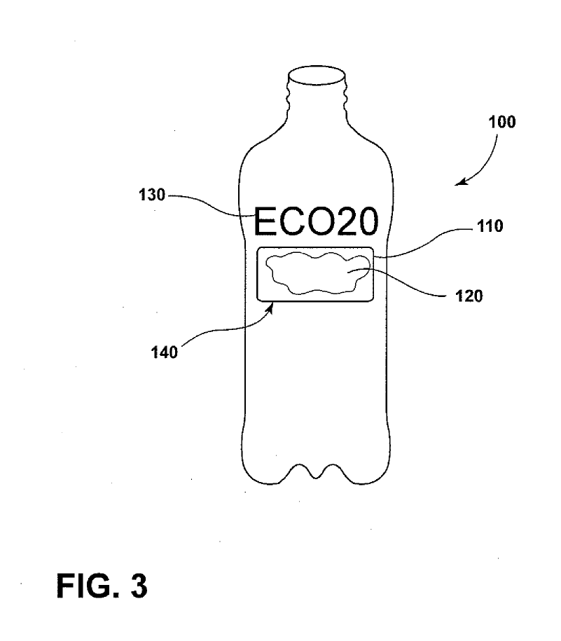

FIG. 3 generally illustrates and embodiment of an article (e.g., container 100) including an intended region 110 and associated printed variable data 120 printed therein. In an embodiment, the method or system may observe a feature of the container (e.g., a formed or embossed letter 130) and/or a position of an intended region (e.g., lower corner position 140), and may then evaluate the printed variable data 120 as to content and/or position.

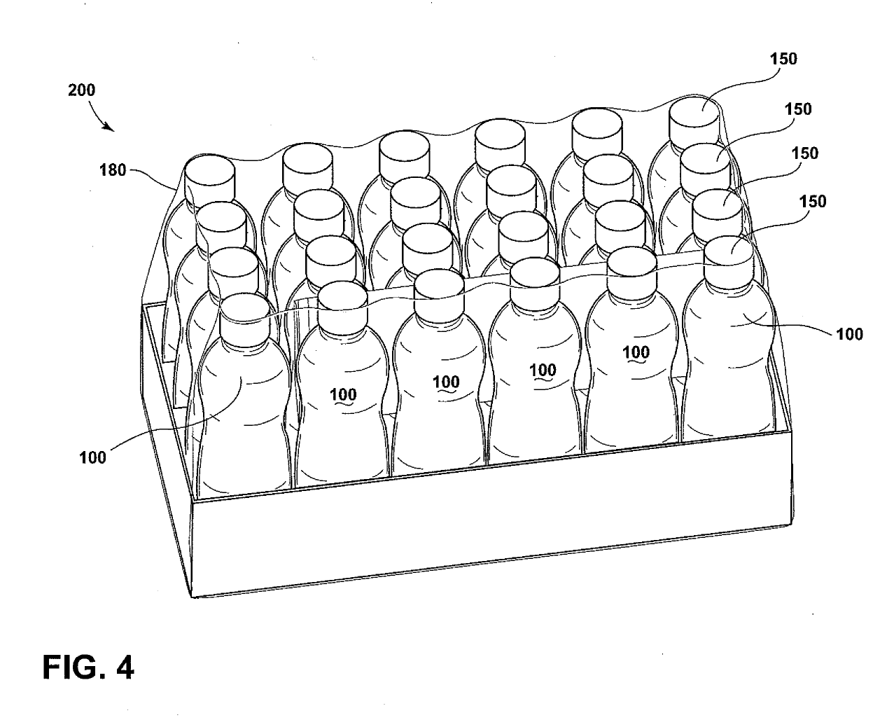

FIG. 4 generally illustrates an embodiment of a multi-pack 200 of articles, i.e., a plurality of containers 100. The containers 100 may be filled with contents, and may include individual closures 150. For example and without limitation, embodiments of multi-packs of articles may include a form of receiving member (e.g., receiving member 170) and/or a form of wrap (e.g., plastic wrap 180). Other embodiments may employ various conventional receiving members, wraps, and/or combination devices known in the industry, including, without limitation, connected plastic rings (e.g., six pack rings or six pack yokes) or the like that are used in connection with multi-packages of bottles.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. A method for customizable printing a multi-pack of articles, the method comprising:
providing data from a database;
electronically generating variable data based on the data from the database;
printing variable data on a plurality of articles;
combining the plurality of similar articles to form a multi-pack of articles.

2. The method of claim 1, wherein the plurality of articles upon which printing occurs are substantially identical.

3. The method of claim 1, wherein the plurality of articles comprise plastic containers.

4. The method of claim 1, wherein the database comprises a relational database.

5. The method of claim 1, wherein the data includes demographic data.

6. The method of claim 1, wherein the variable data includes variable data for generating printed graphics.

7. The method of claim 1, including curing the printed variable data.

8. The method of claim 1, wherein the variable data is printed directly on a portion of the plurality of articles.

9. The method of claim 1, wherein the variable data that is printed is comprised of ink.

10. The method of claim 9, wherein the ink comprises droplets of curable ink that is digitally printed.

11. The method of claim 1, wherein at least a portion of the variable data is randomized.

12. The method of claim 1, wherein the variable data is comprised of droplets of ink that are multi-colored and single-cured.

13. The method of claim 1, wherein a base coat of ink is applied directly to the plurality of articles prior to printing variable data on the base coat.

14. The method of claim 1, including observing a reference associated with the printed variable data.

15. The method of claim 14, wherein the reference comprises a printed symbol or graphic.

16. The method of claim 14, including performing an inspection of the printed variable data utilizing the reference.

17. The method of claim 1, including distributing the multi-packs of articles based on demographic data.

18. The method of claim 17, wherein the demographic data includes current event data, geographic location data, entertainment data, local event data, or combinations of one or more of the foregoing data.

19. The method of claim 1, wherein the multi-packs of articles are distributed to target customers.

20. The method of claim 1, wherein the generation of variable data and the printing of variable data occurs at production line speeds.

21. The method of claim 1, wherein no two articles within the plurality of articles have the same variable data printed thereon.
